(19) United States
(12) Patent Application Publication
(10) Pub. No.: US 2012/0176726 A1
(43) Pub. Date: Jul. 12, 2012

(54) NANOCRYSTALLINE MATERIALS FOR ELECTRONIC APPLICATIONS

(76) Inventors: David Jones, Manhattan, KS (US); Slawomir Winecki, Manhattan, KS (US); Shivanee Dargar, White Plains, NY (US); Justin Millette, Manhattan, KS (US)

(21) Appl. No.: 11/777,828

(22) Filed: Jul. 13, 2007

Related U.S. Application Data
(60) Provisional application No. 60/807,259, filed on Jul. 13, 2006.

(51) Int. Cl. H01G 4/10; C01B 13/00; C04B 35/468; C01B 31/00; C01F 11/18; C08K 3/22; C01F 11/02; B82Y 30/00

(52) U.S. Cl. 361/321.5; 524/413; 423/593.1; 423/594.16; 423/598; 501/137; 423/419.1; 423/430; 977/773

(57) ABSTRACT

Dielectric materials comprising nanocrystalline or nanoparticulate metal oxides or metal carbonates having enhanced dielectric constant values are provided. Specifically, the dielectric materials exhibit high dielectric constant values at low frequencies approaching the DC limit. The dielectric materials also exhibit low dielectric loss factors and high voltage breakdown limits making them well suited for use in capacitors, particularly high energy density capacitors.

### RELATED APPLICATION

The present application claims the benefit of U.S. Provisional Patent Application Ser. No. 60/807,259, filed Jul. 13, 2006, which is incorporated by reference herein.

### BACKGROUND OF THE INVENTION

1. Field of the Invention

The present invention generally pertains to dielectric materials comprising metal oxides that exhibit unusually high dielectric constant values at low frequencies. The metal oxides may be single metal oxides or mixed metal oxides. In certain embodiments, the dielectric materials present a dielectric constant value of greater than about 1400 at 20 Hz. The dielectric materials are particularly suited for use in capacitors that may be employed in a multitude of electronic applications.

2. Description of the Prior Art

High energy density capacitors with reduced size and weight are important for numerous civilian and military applications, including multilayer ceramic capacitors, implantable defibrillators, high power sources, energy storage devices, particle beam accelerators, electric armor, electric guns, and ballistic missile applications. Many of these applications are limited by the performance of existing dielectric materials and capacitor construction. Capacitor requirements for military and scientific pulse power applications are particularly rigorous. High densities of stored energy, measured per unit mass or unit volume of the capacitor, as well as high discharge rate, are the main requirements. In addition, sufficient efficiency of energy recovery and high mechanical strength are necessary for most high energy capacitor applications. Other applications include medical applications (products that repair or replace bone, teeth or other hard tissues), telecommunications, radar applications, health and safety studies, and dielectric heating.

One important military application of high energy density capacitors is the electric armor protection for military vehicles. In this application, low velocity projectiles, mainly rocket propelled grenades (RPGs), approaching the military vehicle are destroyed by a powerful electrical discharge generated by a large-size, high-energy capacitor. Field tests carried out in Great Britain demonstrated that a military tank can be effectively protected from incoming RPGs by an electric armor system weighing 1-2 tons. See, “Armor Plate, Electronic Armor Withstands Rocket-propelled Grenade Strike,” New Scientist, vol. 175, 2002, pp. 6. The high-energy capacitor that constitutes the heart of such a system stores enough energy to effectively vaporize the incoming RPG or similar weapon before the tank armor is penetrated. It is expected that electric armor will be widely implemented for protection of tanks and lighter military vehicles during the next decade. Both the U.S. and British military dedicate significant resources to development and deployment of such systems. It is expected that the development of advanced dielectric materials with increased energy storage density and reduced weight will benefit the electric armor systems by increasing their effectiveness and reducing their weight.

The energy storage density of a capacitor is proportional to the dielectric constant of the dielectric material filling the capacitor and varies as the square of the electric field (voltage) which is applied to the capacitor's electrodes. Therefore, dielectric materials with high values of the dielectric constant, low dielectric loss factor, and high voltage breakdown limit are suitable for high energy density capacitors. Existing capacitor technologies suffer from defects and non-homogeneity in the dielectric material and in capacitor manufacturing. These factors contribute to voltage breakdown. Important voltage breakdown mechanisms include electrical or avalanche breakdown, electrochemical breakdown, and thermal breakdown. Rolled paper or polymer based capacitors have high breakdown voltage but very low dielectric constant, typically in the 2-5 range. Aging and defect characteristics of these capacitors, particularly paper based, are not favorable. Capacitors utilizing ferroelectric ceramic dielectrics, such as barium titanate (BaTiO₃) or strontium titanate (SrTiO₃), typically have a much higher dielectric constant than paper or polymer based systems. However, large ceramic capacitors still have lower breakdown voltage and high dielectric losses. Performance of the existing ceramic capacitors is limited by ceramic powder quality and capacitor manufacturing processes.

Consideration should also be given to the particle or crystallite size of the dielectric material. It is known that ferroelectric and ferromagnetic behaviors of materials can be manifested only for sufficient size elements known as domains. Theoretically, small particles or crystallites that are smaller than the domain size cannot exhibit ferroelectric or ferromagnetic properties. This limitation would eliminate a possibility of very small particles (like nanoparticles or nanocrystalline particles) being ferroelectric or ferromagnetic.

There is a clear need to combine advantages of both types of dielectric materials (rolled paper or polymer based and ferroelectric ceramic), particularly to manufacture material with a high dielectric constant, a high voltage breakdown limit, and low dielectric losses.

### SUMMARY OF THE INVENTION

Dielectrics with the above characteristics can be manufactured that comprise ferroelectric ceramics, particularly nanocrystalline or nanoparticulate metal oxides. The ferroelectric ceramics may be incorporated into suitable polymer matrices utilizing approaches on a nanometric scale so as to provide molecular level dispersion of both components in the dielectric.

In one embodiment of the present invention there is provided a dielectric material comprising a nanoparticulate or nanocrystalline mixed metal oxide or metal carbonate. The dielectric material generally presents a dielectric constant value of greater than about 1400 at 20 Hz.

In another embodiment of the present invention there is provided a dielectric material comprising a nanoparticulate or nanocrystalline mixed metal oxide dispersed in a polymer matrix. The dielectric material has a dielectric constant value of greater than about 1400 at 20 Hz. The mixed metal oxide comprises a first metal selected from the group consisting of alkaline and alkaline earth metals, and a second metal selected from Groups IIIB, IVB and VB of the CAS periodic table. The polymer comprises at least one member selected from the group consisting of polyimides, benzocyclobutene (BCB), polyphenylquinoxaline (PPQ), fluoropolymers, and mixtures thereof.

In still another embodiment of the present invention there is provided a method of making a dielectric material comprising the steps of: (a) mixing a nanoparticulate or nanocrystalline metal oxide with a precursor material comprising an alkali or alkaline earth metal compound; and (b) heating the mixture to a temperature of at least about 950° C. thereby forming a mixed metal oxide material.

In yet another embodiment of the present invention there is provided a capacitor comprising a dielectric material as described herein.

### BRIEF DESCRIPTION OF THE DRAWINGS

FIG. 1 is a drawing showing a capacitor configured to be attached to a circuit board;

FIG. 2 is a side view of a disc-shaped capacitor presenting a dielectric material disposed between opposed electrically conductive plates;

FIG. 3 is a plot showing the dielectric constant measured with respect to frequency for an unsintered barium titanate according to the present invention and a commercially available barium titanate powder;

FIG. 4 is an XRD plot for a barium titanate according to the present invention and two commercially available barium titanate powders;

FIG. 5 is a plot showing the dielectric constant measured with respect to frequency for various barium titanate powders sintered at 100° C. for 12 hours;

FIG. 6 is a plot showing the dielectric constant measured for various barium titanate powders sintered at 500° C. for 2 hours;

FIG. 7 is a plot showing the dielectric constant measured for various barium titanate powders sintered at 1000° C. for 2 hours;

FIG. 8 is a plot showing the effect of the molar ratio of barium and titanium on the dielectric constant; and

FIG. 9 is a plot showing the dissipation factor for several barium titanate materials in accordance with the invention.

### DETAILED DESCRIPTION OF THE PREFERRED EMBODIMENT

The metal oxides (i.e., the ferroelectric or ferromagnetic material) useful in the formation of dielectric materials according to the present invention may be single metal oxides or mixed metal oxides and derivatives thereof. Whichever the case, the dielectric materials exhibit relatively large dielectric constants, generally greater than about 1400 measured at 20 Hz. Further, the dielectric constant may tend even higher a direct current (DC) conditions are approached.

In certain embodiments, the metal oxide comprises a single metal species. Single metal oxides that may be produced in accordance with the present invention comprise the oxides of Ti, Zr, Sr, with titanium oxide (e.g., TiO₂) and zirconium oxide (e.g., ZrO₂) being particularly preferred.

In other embodiments, the metal oxide is a mixed metal oxide comprising a first metal selected from Groups I and II (the alkali and alkaline earth metals) of the CAS periodic table, and a second metal selected from groups IIIB, IVB, and VB. Exemplary mixed metal oxides include mixed metal titanates and mixed metal niobates. Particularly preferred mixed metal oxides for use with the present invention include barium titanate (e.g., BaTiO₃), strontium titanate (e.g., SrTiO₃), aluminum titanate, magnesium titanate, lead zirconium titanate, calcium titanate, zinc titanate, and mixtures thereof.

In certain embodiments, the mixed metal oxide may present only two different metal species within the same crystal structure. In such embodiments are distinguished from solid solutions of metals and metal oxides that comprise more than two different metal species within the same crystal structure. An exemplary solid solution that is distinguished from this embodiment is barium/strontium titanate.

In still other embodiments, the dielectric material may comprise a carbonate material such as an alkali or alkaline earth metal carbonate, particularly barium or strontium carbonate.

The metal oxide materials are preferably nano crystalline in nature, meaning that the materials generally present average crystallite sizes of about 100 nm or less. In certain embodiments, the materials present average crystallite sizes of less than about 50 nm, and more particularly between about 2 to about 50 nm. As used herein, the term “crystallite size” is not necessarily synonymous with the term “particle size.” It is possible, and in many cases very probable, that the materials will present particle sizes that are greater than the crystallite size. In certain embodiments of the present invention, the metal oxide materials present average particle sizes of between about 100 nm to about 100 μm, more particularly between about 500 nm to about 50 μm, and even more particularly between about 1 to about 25 μm. The metal oxide materials also present surface areas between about 10 to about 1,000 m²/g, more particularly between about 20 to about 800 m²/g, and even more particularly between about 50 to about 700 m²/g. It is further understood that the discussion of the physical properties, methods of synthesis, and handling of the metal oxide materials described herein is equally applicable to the metal carbonates that may be used in the dielectric materials according to the present invention. Thus, in any property ranges, methods, or procedures the term “metal carbonate” may be substituted for the term “metal oxide.”

The metal oxide material may also be doped with one or more additional materials to improve the dielectric properties thereof. Such dopants include lead, magnesium, tantalum, lanthanum, oxides thereof, or fluorides (e.g., CaF₂). In one particular embodiment, titanates doped with one of the foregoing are provided.

The single metal oxide materials may be synthesized by the aerogel techniques from Utamapanya et al., Chem. Mater. 3:175-181 (1991), incorporated by reference herein.

The mixed metal oxide materials may be synthesized via a solid state reaction between a single metal oxide material and an alkali or alkaline earth precursor material, such as an alkali or alkaline earth metal carbonate, nitrate or hydroxide. Each solid reactant is provided in a fine particulate or powder form and thoroughly mixed together in the desired ratio. In certain embodiments, the components are wet milled and subsequently dried prior to being reacted. The metal oxide component may be a high surface area metal oxide material available from NanoScale Corporation, of Manhattan, Kans., under the name NanoActive®. As is explained further below, the dielectric properties of the final material may be affected by the ratio of each reactant. The reactant mixture is then heated to a temperature of between about 600° C. to about 1100° C. During the heating process, the metal oxide and precursor material react to form the final mixed metal oxide species. Also, during the process, a gas, such as CO₂ (when a carbonate precursor is used), may be liberated.

In other embodiments, the mixed metal oxide materials may be formed using a sol-gel technique, such as those described in co-pending U.S. patent application Ser. No. 11/759,106, incorporated by reference herein. Sol-gel chemistry generally involves the formation of a solid product via a homogenous liquid phase chemical reaction between two or more liquid precursors.

In certain embodiments, the above-described metal oxide material may be incorporated into a suitable solid matrix material so as to improve the mechanical strength and electrical insulation characteristics of the resulting dielectric material. The solid matrix material itself should possess high mechanical strength and good insulative properties. Exemplary matrix materials include electrically insulative polymers that are used in electronic applications. Exemplary polymers comprise polyimides, benzocyclobutene (BCB), polyphenylquinoxaline (PPQ), and fluoropolymers. The ferroelectric component of the dielectric material may be incorporated into the polymer matrix by simple mixing, milling, or preferably by a bottom up synthesis in liquid polymer precursor. In the bottom up approach, the formation of the solid ferroelectric material may be carried out in a polymer precursor prior to or during the polymerized process. Such results in optimum dispersion of all components thereby preserving the mechanical strength and insulation properties of the dielectric material.

The dielectric material may then be formed into the desired shape by any operation known to those of skill in the art, such as by pressing the powder or particles together into a pellet. Binder materials such as polyvinyl alcohol (PVA), polyvinyl butyral, polyvinyl methacrylate, acrylic resin, and dioctyl phthalate glass bonding agent may also be incorporated into the dielectric material so as to improve its handling characteristics during the manufacturing stage.

The dielectric material may undergo a mild sintering operation in order to alter the properties of the material. In certain embodiments, however, the sintering operation is conducted for a relatively short period of time (e.g., less than about 1 hour) at a temperature that does not exceed about 200° C. In many embodiments, though, no sintering is applied to the dielectric material.

The dielectric materials comprising metal oxides made in accordance with the present invention generally exhibit much higher dielectric constants compared with conventional dielectric materials comprising metal oxides of the same elemental makeup. The present dielectric materials generally exhibit a dielectric constant value of greater than about 1400 when measured at 20 Hz. As shown in the Figures, dielectric constant values may vary depending upon the frequency applied to the dielectric material. The increased dielectric constants for the present material versus the commercial materials is most pronounced at the lower frequencies approaching the direct current limit. In other embodiments of the invention, the dielectric materials may exhibit a dielectric constant value of greater than about 2000 at 20 Hz, and in other embodiments, greater than about 5000 at 20 Hz. It is understood that the dielectric materials in accordance with the present invention may comprise, consist of, or consist essentially of the above-described metal oxides. The dielectric materials may also include other components such as binders that do not significantly affect the material's dielectric constant. Other components such as polymer matrices and dopants may also be included so as to enhance the material's dielectric constant.

It has also been discovered that the domain size can be reduced for small particles and small crystallite sizes provided appropriate surface conditions are generated at the particle/crystallite interface. Such surface conditions are achieved through appropriate selection of coatings, dopants, or additive materials. A discussion of reduction in domain size may be found in S. Gangopadhyay et al., “Magnetic Properties of Ultrafine Iron Particles,” Phys. Rev. B, vol. 45, pp. 9778-9787, 1992, incorporated by reference herein.

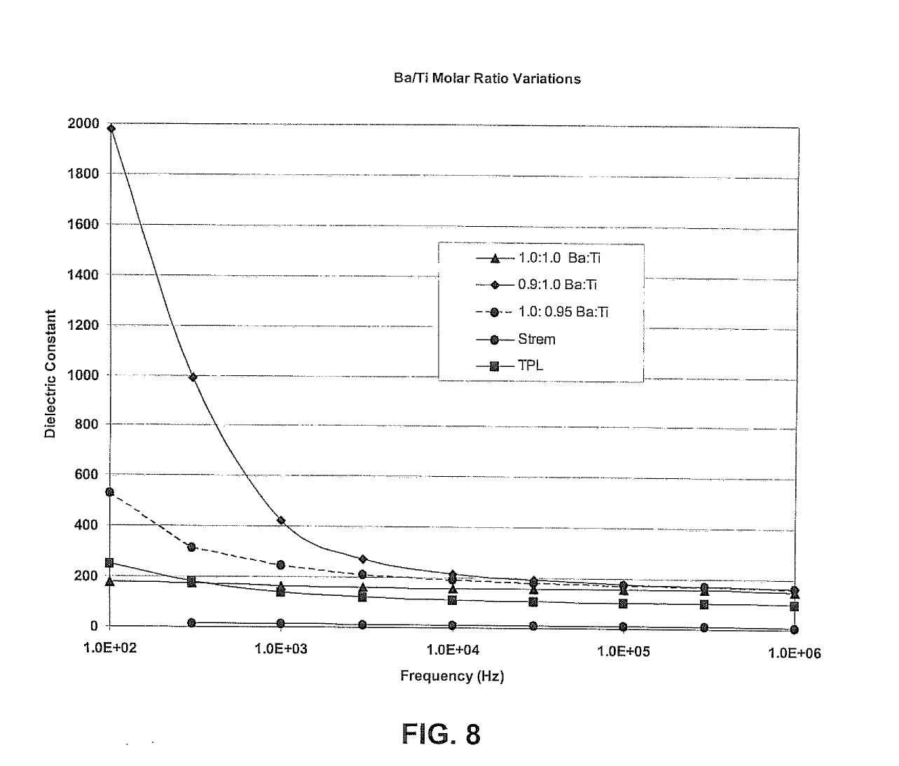

The dielectric constant may also be affected depending upon the ratio of the metal species in the mixed metal oxide material. Turning to FIG. 8, the plot shows how the dielectric constant value can be varied by altering the ratio of barium to titanium present in the metal oxide material comprising the dielectric. Using stoichiometric amounts of barium and titanium (a 1:1 ratio) a nearly level dielectric constant value may be achieved over a wide frequency range. However, reducing the amount of titanium to give a 1:0.95 ratio of barium to titanium causes the dielectric constant to increase at lower frequencies. Providing an excess of titanium, shown as a 0.9:1 ratio of barium to titanium results in a significant jump in the dielectric constant value when measured at lower frequencies. Although, in the latter two instances, the dielectric constant value does not remain level over a broad frequency range, but tends to decrease at the higher frequencies. It is noted that the actual values of the dielectric constants were not necessarily consistent with those shown in the other Figures. These inconsistencies are believed to be attributable to the particular test methods employed and methods of calculating the dielectric constant value. The values for the commercial Strem and TPL materials tested employing the same test procedures are shown for reference. These inconsistencies not withstanding, the data presented in FIG. 8 is useful to illustrate the ability to vary the dielectric constant values by adjusting the ratio of barium to titanium.

Thus, the ratio of the metal species present within the mixed metal oxide material can be adjusted to give a dielectric material having the desired properties. In certain embodiments, the ratio of the alkali or alkaline earth metal to the second metal (selected from Groups IIIB, IVB and VB) is between about 0.25:1 to about 1:0.25. In other embodiments, this ratio is between about 0.5:1 to about 1:0.5, and in still other embodiments the ratio is between about 0.75:1 to about 1:0.75. The ratio of the metal species may be adjusted by simply controlling the ratios of the reactants from which the metal oxide materials are formed.

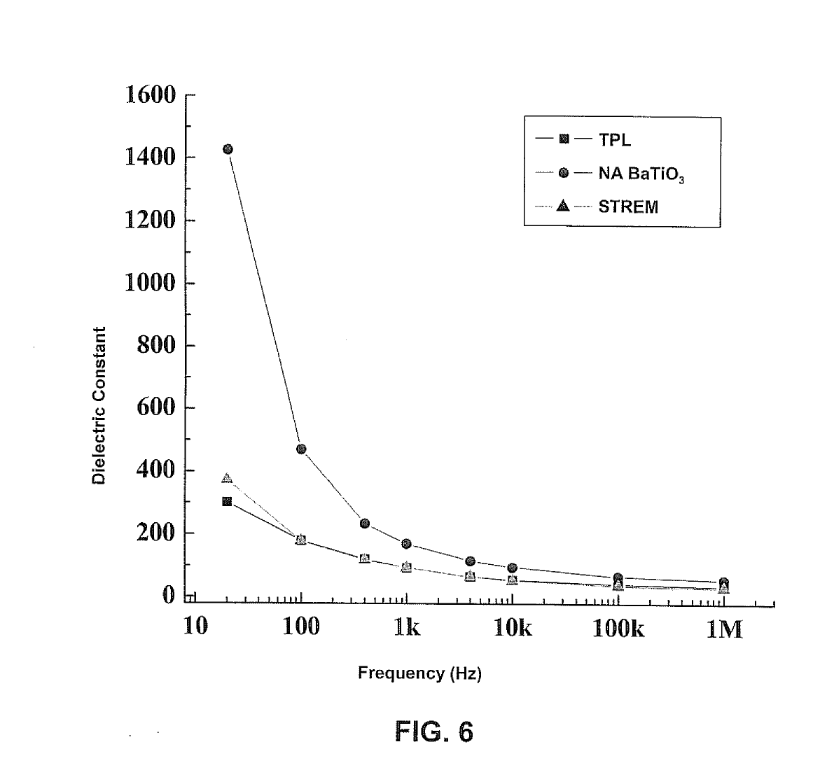

The dielectric materials having substantially level dielectric constant values over a wide range of frequencies are particularly suited for use in electronic application that are subject to varying frequencies, such as in computer circuitry. In those applications, it may be preferable to utilize a dielectric material comprising a mixed metal oxide wherein the ratio of the metal species is such that provides a more level dielectric constant value over a range of frequencies. In direct current (DC) applications, the varying of the dielectric constant value with changes in frequency is not a concern. Therefore, in certain applications in which a very high dielectric constant value is desirable, the ratio of the metal species may be adjusted as shown, for example, in FIG. 6 to provide the greatest possible dielectric constant value at or near the DC limit. Thus, the present dielectric materials are suitable for use in a wide range of electronic applications.

The dielectric materials made according to the present invention may also exhibit enhanced dissipation or electrical loss properties. The dissipation factor is one means of quantifying the dissipation or loss properties of a dielectric material. A material's dissipation factor is essentially a ratio of the material's resistive power loss to the material's capacitive power. In capacitors, the dissipation factor (DF) is the ratio of the capacitor's resistance ® to its capacitive resistance (X_{C}), or

DF=R/X_{C},

wherein X_{C}=1/ωC and wherein ω is the angular frequency (2πf).
Generally, a lower DF value is an indicator of a higher quality capacitor.

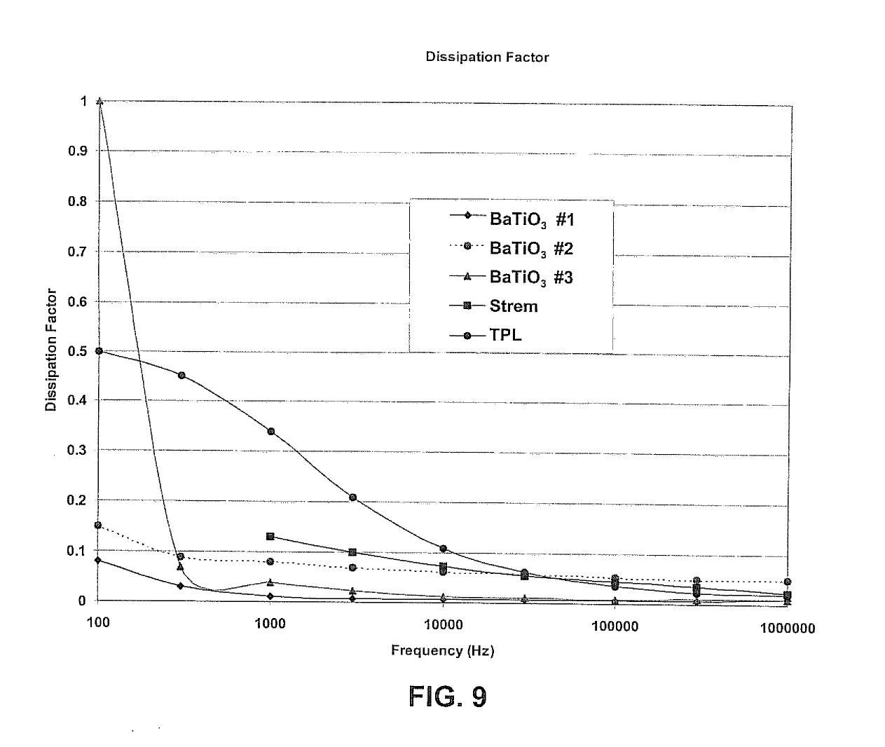

Turning to FIG. 9, the dissipation factors for three nanocrystalline barium titanate samples made in accordance with the present invention (NA-BaTiO₃ #1, #2, and #3) were determined over various frequencies. The nanocrystalline dielectric materials, while being essentially identical from a chemical makeup standpoint (a 1:1 ratio of Ba and Ti), were produced according to different methods. NA-BaTiO₃ #1 was produced via a solid state reaction and then pressed into pellets. A minor amount of polyvinyl alcohol binder was added to assist in holding the pellet together. NA-BaTiO₃ #2 was produced according to a sol-gel preparation method. Both NA-BaTiO₃ #1 and #2 were sintered at 1100° C. for 10 hours. NA-BaTiO₃ #3 was produced according to a method whereby the precursor materials were pressed into a pellet and the barium titanate formation reaction occurred in pellet form with no subsequent sintering. The results indicate that NA-BaTiO₃ #1 and #2 exhibit surprisingly low dissipation factors at low frequencies. The dissipation factor for NA-BaTiO₃ #3 was higher at the same lower frequencies, however, all materials exceeded the performance of their commercial counterparts at frequencies of 1000 Hz. Thus, in certain embodiments of the present invention, the dielectric materials present dissipation factors of less than about 0.1 measured at 1000 Hz. In other embodiments, the dielectric materials exhibit dissipation factors of less than about 0.2 measured at 100 Hz.

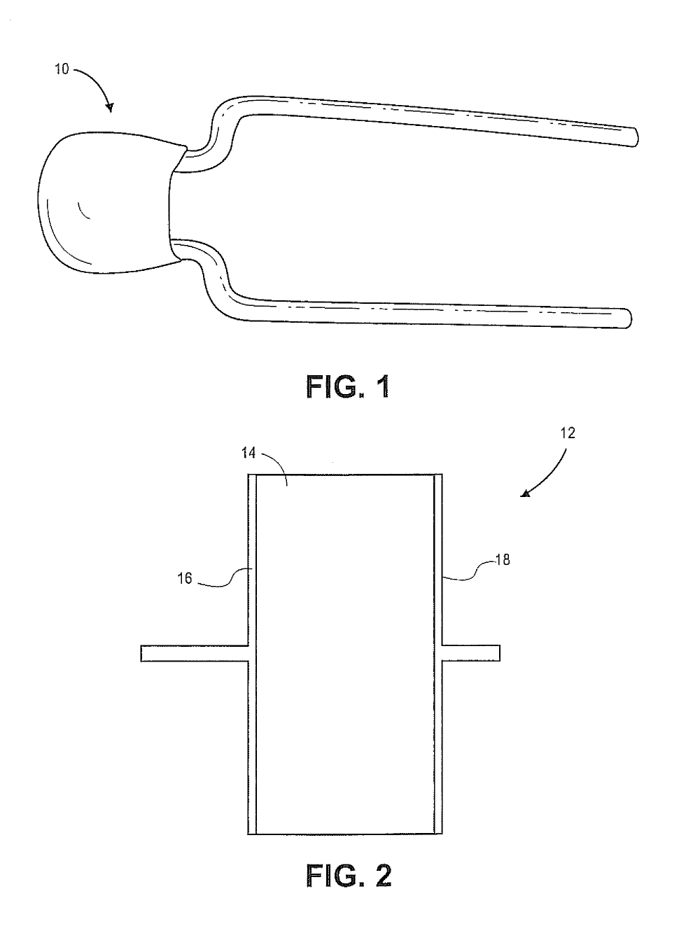

The dielectric materials described herein are particularly suited for use in capacitors such as capacitor 10 of FIG. 1 that may be attached to a circuit board. The dielectric materials may be used in other types of capacitors as well in both civilian and military applications including multilayer ceramic capacitors, polymer film capacitors, composite film capacitors, implantable defibrillators, high power sources, energy storage devices, particle beam accelerators, electric armor, electric guns, and ballistic missiles.

### Example

The following example sets forth one embodiment of a mixed metal oxide material in accordance with the invention that exhibits extraordinarily high dielectric constant values, particularly at low frequencies. It is to be understood, however, that this example is provided by way of illustration and nothing therein should be taken as a limitation upon the overall scope of the invention.

In this Example, barium titanate was synthesized using a solid-phase reaction between NanoActive® TiO₂ (available from NanoScale Corporation, Manhattan, Kans.) and commercial barium carbonate. This barium titanate compound is referred to herein as NA-BaTiO₃. A stoichiometric amount of each reactant powder was thoroughly mixed. In earlier trials, mixing was performed using a mortar and pestle, however, in order to achieve a more homogenous mixture, approximately 100g of a stoichiometric amount of reactant mixture was milled for 30 minutes in a high intensity media mill. The reactant mixture was then heated to temperatures in the range of 600° C. to 1100° C. in a microwave furnace (CEM Corporation) under an atmosphere of air. The BaCO₃ loses CO₂ at about 800° C. with the formation of the orthotitanate (Ba₂TiO₄), and at around 950° C. metatitanate (BaTiO₃) begins to form. A further increase in temperature results in complete formation of BaTiO₃ and elimination of other phases. The characteristics of the mixture indicated the formation of BaTiO₃ at 1000° C. in 1 hour. This reaction is generally described by the following equation:

BaCO₃(s)+TiO₂(s)→BaTiO₃(s)+CO₂(g)

Two commercially available powders were used for comparison of physical characteristics, electronic properties, and cost. The manufacturers/distributors of these powders were TPL, Inc., of Albuquerque, N. Mex., and Strem Chemicals, Inc., of Newburyport, Mass. The synthesized titanate powders were characterized for their phases using XRD and compared with the commercially available titanate powders, as shown in FIG. 2. The XRD pattern of all three types of BaTiO₃ are essentially identical.

The synthesized and commercial titanate powders were also characterized for specific surface area, crystallite size, and particle size. The results from these analyses are given in Table 1.

TABLE 1

| Properties | NA-BaTiO₃ | TPL | Strem |
|---|---|---|---|
| XRD Pattern | BaTiO₃ | BaTiO₃ | BaTiO₃ |
| Specific surface area (m²/g) | 0.42 | 3.04 | 3.64 |
| Particle size d(0.5) (μm) | 8.55 | 3.21 | 1.46 |
| Crystal size (nm) | 30-35 | 47 | 19 |

Specific surface area of NA-BaTiO₃ is significantly smaller than that of the Strem and TLP materials, while its particle size is larger than both commercial materials. The crystalline size of NA-BaTiO₃ is larger than the Strem material but smaller than the TLP material.

Electrical properties for the synthesized and commercial titanate powders were measured using samples pressed into discs 12.7 mm in diameter and approximately 1-2 mm thick. FIG. 2 schematically depicts (although not necessarily to scale) the construction of a capacitor 12 comprising a disc 14 of the dielectric material. All pellets were pressed using a CARVER laboratory Press (Model C), using a set of stainless steel dies and a load of 5,000-10,000 lbs. The discs were then sintered at different temperatures for different residence times under an atmosphere of air. Conductive surfaces 16, 18 (electrodes) were created by painting both flat surfaces of each disk with silver paint obtained from Structure Probe, Inc. The paint was dried by heating the discs at 100° C. for 12 hours.

Measurements of the dielectric constant were carried out using an HP 4284A Precision LCR meter capable of operation in the 20 Hz-1 MHz frequency range. The measurements were conducted at 100 Hz, 400 Hz, 1 kHz, 10 kHz, 100 kHz and 1 MHZ. The dielectric constant values were calculated from the measured capacitance and disc dimensions using the following flat capacitor equation:

C=∈₀∈_{R}(S/d)

wherein ∈₀ is the dielectric constant for vacuum 8.854×10⁻¹² F/m, E_{R} is the dielectric constant for the sample, S is the surface area of one plate, and d is the distance between the plates.

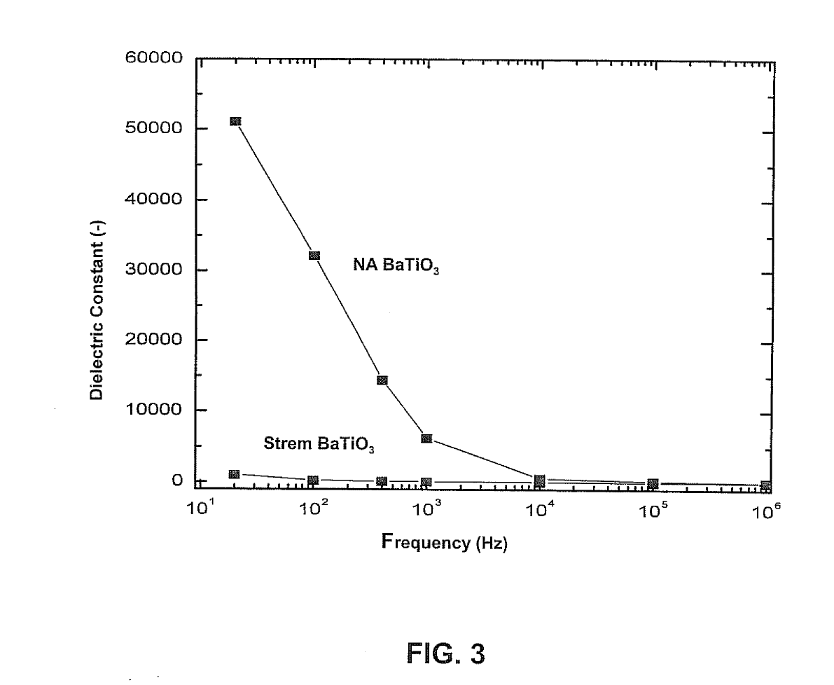

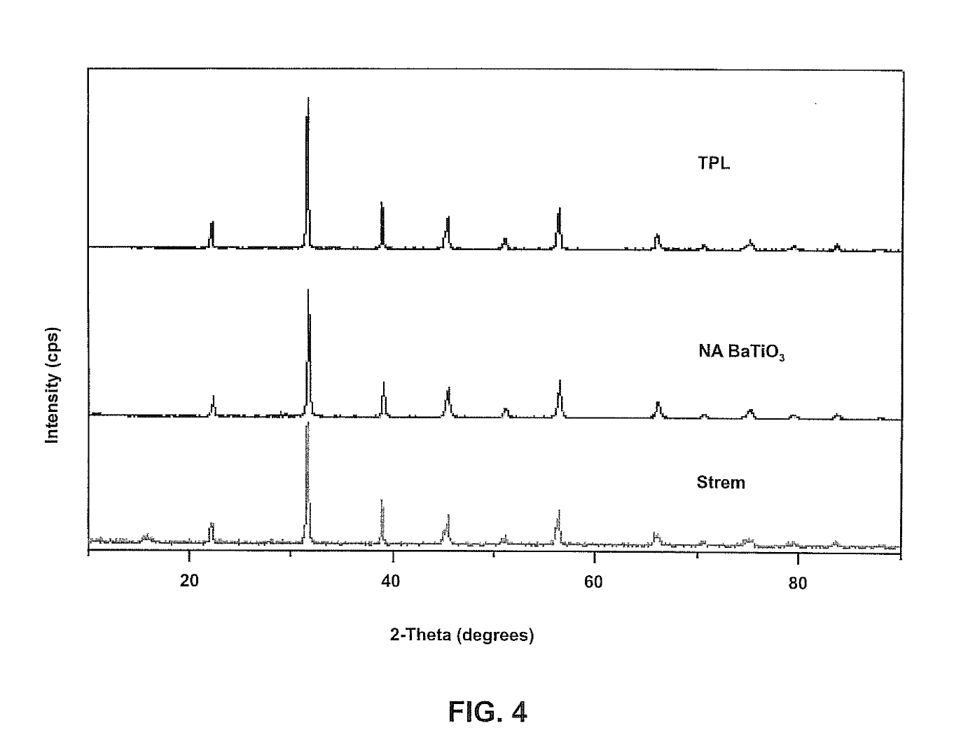

FIG. 3 depicts the dielectric constant for unsintered NA-BaTiO₃ and the Strem material measured at various frequencies. The NA-BaTiO₃ exhibited remarkably large dielectric constant values compared to the Strem material, particularly at lower frequencies.

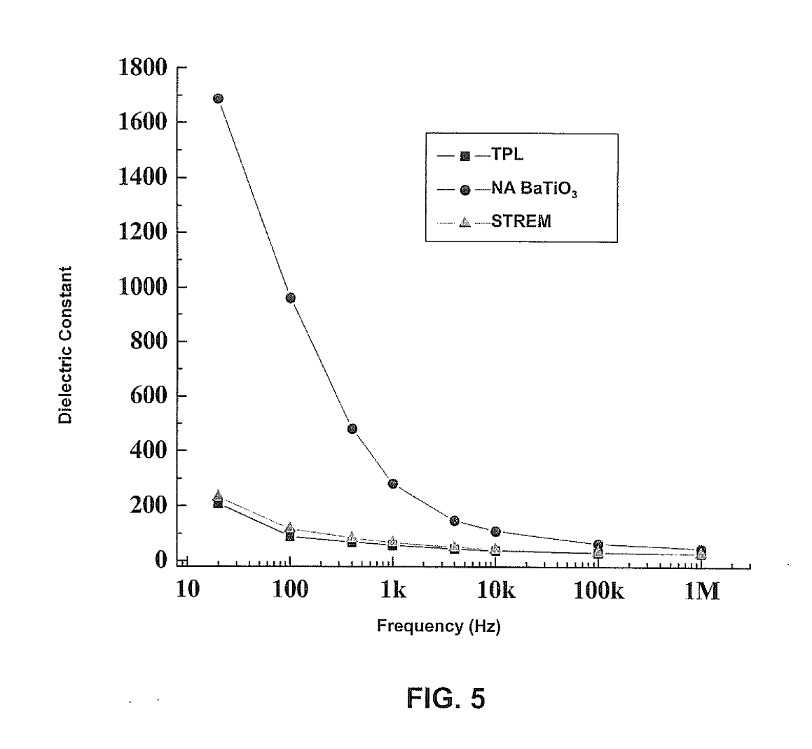

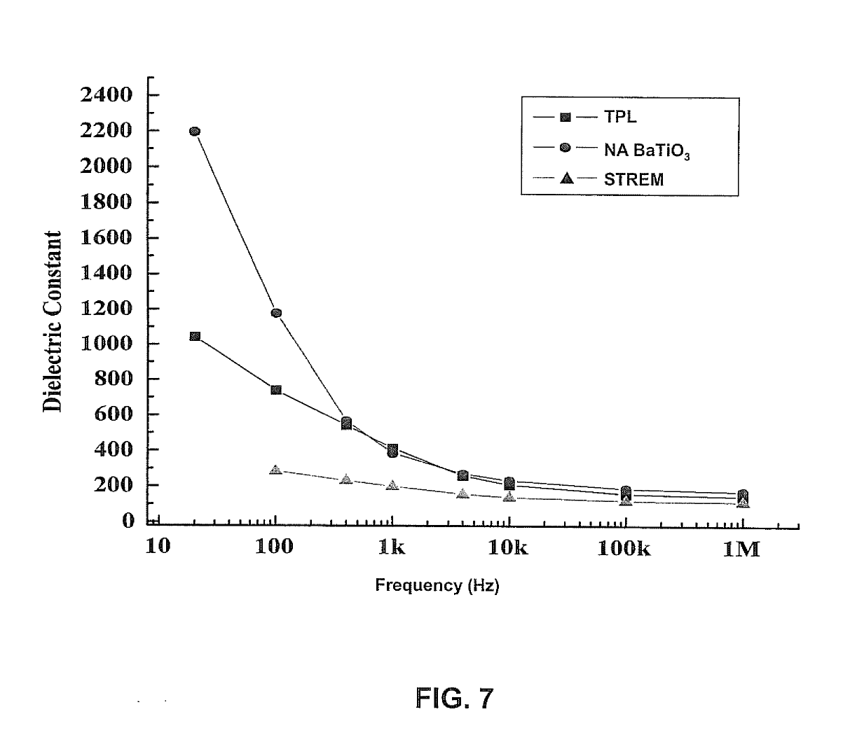

The synthesized and commercial powders were sintered at different temperatures to study the effect of sintering conditions on electrical properties. The results from the electrical measurements for the sintered BaTiO₃ are shown in FIGS. 5-7. The data obtained indicated that sintering significantly reduces the maximum value of the dielectric constant, although the specific temperature and time of sintering are of less importance. Sintered samples exhibited a dielectric constant ranging from 1400 to 2200 at 20 Hz. In all cases, the NA-BaTiO₃ provided significantly greater low-frequency limits of the dielectric constant as compared to both commercial materials.

The nanocrystalline BaTiO₃ synthesized according to the present invention presents unique characteristics as compared to commercially available forms of BaTiO₃. Primarily, it was observed that materials according to the present invention exhibit extremely high dielectric constants at low frequencies. Surprisingly, there does not appear to be a direct correlation between the XRD, BET, and particle size characteristics and the unusually high values of the dielectric constant observed for the NA-BaTiO₃ at low frequencies. FIG. 3 shows this dramatic effect with dielectric constant values reaching 50,000 at 20 Hz, with similar or higher dielectric constants expected at the DC limit. This opens a possibility that nanocrystalline BaTiO₃ can be advantageously used in high energy density capacitors and electric armor applications since these systems typically operate in DC mode. Theoretically, the energy stored in the capacitor, assuming constant voltage conditions, is proportional to the dielectric constant for the dielectric material used. This would result in a 50-fold improvement for nanocrystalline BaTiO₃ over traditional forms of this material with much lower dielectric constant, usually below 1000.

1. A dielectric material comprising a nanoparticulate or nanocrystal line mixed metal oxide or metal carbonate, said dielectric material having a dielectric constant value of greater than about 1400 at 20 Hz.

2. The material according to claim 1, wherein said dielectric constant value is greater than about 2000 at 20 Hz.

3. The material according to claim 1, wherein said mixed metal oxide comprises a first metal selected from the group consisting of alkaline and alkaline earth metals.

4. The material according to claim 3, wherein said mixed metal oxide comprises a second metal selected from Groups MB, IVB or VB of the CAS periodic table.

5. The material according to claim 4, wherein said material is doped with a substance different from said first and second metals.

6. The material according to claim 5, wherein said dopant is selected from the group consisting of lead, magnesium, lanthanum oxides, fluorides, and mixtures thereof.

7. The material according to claim 6, wherein said second metal is titanium or niobium.

8. The material according to claim 1, wherein said dielectric material comprises a metal carbonate.

9. The material according to claim 8, wherein said metal carbonate is barium carbonate or strontium carbonate.

10. The material according to claim 1, wherein said material further includes a matrix in which said metal oxide is dispersed.

11. The material according to claim 10, wherein said matrix is a polymer selected from the group consisting of polyimides, benzocyclobutene (BCB), polyphenylquinoxaline (PPQ), fluoropolymers, and mixtures thereof.

12. The material according to claim 1, wherein said dielectric material presents a dissipation factor of less than about 0.1 at 1000 Hz.

13. A dielectric material comprising a nanoparticulate or nanocrystalline mixed metal oxide dispersed in a polymer matrix, said dielectric material having a dielectric constant value of greater than about 1400 at 20 Hz, said mixed metal oxide comprising a first metal selected from the group consisting of alkaline and alkaline earth metals, and a second metal selected from Groups IIIB, IVB and VB of the CAS periodic table, said polymer comprising at least one member selected from the group consisting of polyimides, benzocyclobutene (BCB), polyphenylquinoxaline (PPQ), fluoropolymers, and mixtures thereof.

14. A method of making a dielectric material comprising the steps of:
(a) mixing a nanoparticulate or nanocrystalline metal oxide with a precursor material comprising an alkali or alkaline earth metal compound; and
(b) heating said mixture to a temperature of at least about 950° C. thereby forming a mixed metal oxide material.

15. The method according to claim 14, further including:
(c) combining said mixed metal oxide with an insulating matrix material.

16. The method according to claim 15, wherein said matrix material is a polymer selected from the group consisting of polyimides, benzocyclobutene (BCB), polyphenylquinoxaline (PPQ), fluoropolymers, and mixtures thereof.

17. The method according to claim 16, wherein said method is performed without sintering said dielectric material.

18. The method according to claim 14, wherein said precursor material is selected from the group consisting of alkali and alkaline earth metal carbonates, nitrates, and hydroxides.

19. A capacitor comprising a dielectric material that includes a nanoparticulate or nanocrystalline metal oxide or metal carbonate, said dielectric material having a dielectric constant value of greater than about 1400 at 20 Hz.

20. The capacitor according to claim 19, wherein said metal oxide is a mixed metal oxide.

21. A capacitor comprising the dielectric material of claim 13.
